(19) United States
(12) Patent Application Publication
(10) Pub. No.: US 2026/0227214 A1
(43) Pub. Date: Aug. 6, 2026

(54) PROTECTIVE DEVICE FOR SENSORS

(71) Applicant: Pepperl + Fuchs SE, Mannheim (DE)

(72) Inventors: Stephan TEMME, Ludwigshafen (DE); Abdullah KARIMI, Lampertheim (DE)

(73) Assignee: Pepperl + Fuchs SE, Mannheim (DE)

(21) Appl. No.: 19/156,003

(22) PCT Filed: Feb. 2, 2024
(86) PCT No.: PCT/EP2024/052629

§ 371 Date: Aug. 13, 2025

(30) Foreign Application Priority Data
Feb. 15, 2023 (DE) 10 2023 103 620.3

(51) Int. Cl. G01D 11/24

(52) U.S. Cl. CPC G01D 11/245

(57) ABSTRACT

A protective device (1) for a proximity sensor (6) includes a housing (17) with an opening (4), via which the proximity sensor (6) can be inserted into the housing (17). The housing (17) is composed of at least one layer of a plastically or elastically deformable material, as a result of which the housing (17) is able to convert the impact energy, which acts on the housing (17) as a result of an impact, into deformation energy, so that the impact energy is not forwarded to the proximity sensor (6). This prevents damage to the proximity sensor (6).

### CROSS-REFERENCE TO RELATED APPLICATION

This application is a national stage application, filed under 35 U.S.C. § 371, of International Patent Application PCT/EP2024/052629, filed on Feb. 2, 2024, which claims the benefit of German Patent Application DE 10 2023 103 620.3, filed on Feb. 15, 2023.

### TECHNICAL FIELD

The invention relates to a protective device for sensors.

### BACKGROUND

Sensors are components that can be used to ascertain chemical or physical properties. However, sensors are also used to qualitatively or quantitatively ascertain the material properties of an environment.

If these sensors are to be used in Ex areas (areas where there is a risk of explosion), they must pass an impact test in which they are exposed to a certain impact energy, because there should be no ignition sources in Ex areas. For this purpose, an impact test is carried out using an impact weight. If an impact test is carried out according to EN 60079-0 or IEC 60079-0, the impact is carried out with an energy of 6.867 joules (=~7 joules in common parlance). However, the impact may also be carried out with a reduced energy of 3.924 joules (=~4 joules in common parlance).

The desired impact and shock resistance can be achieved by additional protective devices, such as damping and spring elements.

Such a proximity switch with an impact and shock absorption device is known from DE 10 2012 223 261 B4 and from DE 10 2012 200 478 A1, this having an upper part and a lower part, wherein the upper part contains the components to be protected against impact and shock and the lower part serves for fastening to a support surface, wherein a damping element for dampening impacts and shocks is arranged between the upper part and the lower part.

Sensors with a protective device are also described, for example, in DE 20 2013 973 U1, DE 10 2018 120 978 A1 and DE 100 65 384 A1.

Furthermore, DE 10 2015 221 312 B3 describes an inductive sensor with a cylindrical housing made of rigid material, which has a cover on the front side, a cylinder tube and a rear plug with an electrical connection, as well as a first O-ring arranged between the front section and the cylinder tube, and a second O-ring, wherein the second O-ring is positioned by an annular groove in the front section and a support in the cylinder tube and is deformable by an impact or shock on the front section, wherein the front section and the cylinder tube have corresponding widened portions on the front side that serve as stops, wherein in the unloaded state there is an air gap between the first widened portion in the plug and the second widened portion in the cylinder tube, wherein a displacement path of the cover is determined by the width of the air gap, and wherein the displacement path dampens the energy of an impact and/or shock.

Finally, sensors are known from DE 10 2005 013 242 A1, DE 10 2021 206 893 A1 and DE 10 2020 106 829 A1 which have as a protective device a housing consisting of a deformable material.

However, the known protective devices are used for a very specific sensor and are therefore not universally usable. A particular protective device tailored to each sensor therefore has to be used.

### SUMMARY

The object of the present disclosure is to provide a protective device for sensors, wherein the protective device not only has improved impact and shock resistance, but is also suitable for sensors of different designs, without the sensors having to be impact and shock resistant.

This object is achieved according to the features as described and claimed.

The disclosure therefore relates to a protective device for a sensor, wherein the protective device has a housing with an opening. The sensor can be inserted into the housing of the protective device via this opening. As a result, the sensor is at least partially arranged in the interior of the housing, as a result of which the sensor is at least partially surrounded by this protective device. The protective device thus surrounds at least the part (also called the active area) of the sensor exposed to the impact. The housing consists of at least one layer of a plastically or elastically deformable material. This at least one layer of the housing consists of a material which has a minimum deformability of at least 2% and a hardness in the range of 10 Shore D to 100 Shore D. This at least one layer can also be reinforced by fibres and fabrics or braids made from these fibres.

If an impact is exerted on the protective device during an impact test, the protective device can absorb the impact energy and convert it into potential deformation energy. This prevents the sensor from being damaged because the impact energy is not forwarded to the sensor. After the housing has been deformed by the impact, it returns to its original shape. This protective device can be used for different types of sensors, such as ultrasonic sensors, proximity sensors or optical sensors.

The protective device may be constructed in one or more parts. For example, it is possible to construct the protective device in two parts. In this case, the protective device consists of a first, front protective element and a second, rear protective element, so that the housing is formed by these two protective elements. This modular design makes it possible to accommodate sensors of different sizes in the protective device. If, for example, the size of the housing of a one-part protective device is not sufficient to accommodate the active surfaces of a sensor in this protective device, an additional module can be attached to the housing of this protective device to enlarge the housing of this protective device.

In a particular exemplary embodiment, the protective device may have an internal thread in the interior of the housing of the protective device. An inner sleeve can be arranged on this internal thread, to which a sensor can in turn be fastened. However, it is also conceivable for the corresponding sensor to be attached directly to this internal thread of the housing.

The inner sleeve has an external thread, so the inner sleeve can be fastened to the internal thread of the housing via the external thread. Especially if the inner sleeve has at least one layer of elastically or plastically deformable material, this sleeve forms an additional impact protection element. It is conceivable that this at least one layer can also be reinforced by fibres.

A fastening device is provided inside the protective device, via which the sensor can be fastened to the protective device. This fastening device may be configured, for example, as a spring-loaded suspension or as a clamping element. The fastening device may also be an internal thread of the inner sleeve, so a sensor can be screwed in using the internal thread of the inner sleeve.

Advantageously, a gap in which an impact protection element is located is arranged between the sensor, which is arranged at least partially in the housing of the protective device, and an internal wall arrangement of the housing. This impact protection element has a minimum deformability of at least 2% and a hardness in the range of 10 Shore D to 100 Shore D. This impact protection element may be a foamed material. However, it is also possible to provide a gaseous medium (for example air) as an impact protection element in the gap.

As already explained, the housing of the protective device consists of at least one layer of a plastically or elastically deformable material. The preferred material is a cross-linked elastomer, a thermoplastic elastomer or a post-cross-linked thermoplastic elastomer. This at least one layer may can be additionally reinforced by a fibre system. Instead of an elastomer, a metallic material with a face-centred cubic lattice structure (for example chromium-nickel steels, chromium-nickel-molybdenum steels or chromium-manganese-molybdenum steels) can also be used.

For example, the housing may consist of three layers arranged one above the other, each layer consisting of a different elastomer. For example, only one layer, such as the middle layer, can be reinforced by a fibre system. In another example, the housing may consist of two layers, wherein an inner layer, namely the layer facing the sensor, is made of a post-cross-linked thermoplastic elastomer and the outer layer is made of a metallic material with a face-centred cubic lattice structure (for example a chromium-manganese-molybdenum steel or a chromium-manganese-molybdenum steel). The post-cross-linked thermoplastic elastomer can be additionally reinforced by fibres here.

These materials are particularly good for the protective device because they exhibit high deformability combined with sufficiently high stiffness (modulus of shear, modulus of elasticity). If an impact is applied to the protective device, it deforms because these materials convert the impact energy into deformation energy. After deformation, the protective device returns to its original shape. Since the protective device converts the impact energy into deformation energy and thus does not forward the impact energy to the sensor, damage to the sensor inside the protective device is prevented.

It is also explicitly proposed to combine several features of the individual embodiments described.

### BRIEF DESCRIPTION OF THE DRAWINGS

The present invention is explained in more detail below by reference to the accompanying drawings.

FIG. 1 shows a perspective view of a first variant of a protective device for a sensor;

FIG. 2 shows a perspective view of an arrangement consisting of the protective device according to FIG. 1 and a sensor;

FIG. 3 shows a longitudinal section through the arrangement consisting of the protective device and sensor shown in FIG. 2;

FIG. 4a shows a perspective view of a second variant of a protective device for a sensor;

FIG. 4b shows a section trough the protective device shown in FIG. 4a and

FIG. 5 shows a perspective view of a third variant of a protective device for a sensor.

### DETAILED DESCRIPTION

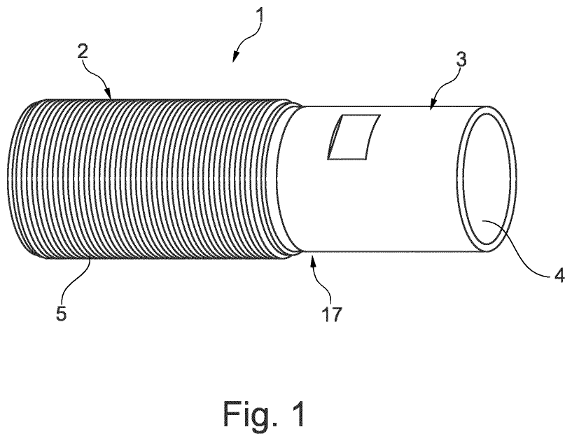

FIG. 1 illustrates a first variant of a protective device 1 for a sensor. The protective device 1 is configured in two parts and consists of a first, front protective element 2 and a second, rear protective element 3. The first, front protective element 2 and the second, rear protective element 3 together form a housing 17. The protective device 1 has an opening 4 in the rear protective element 3 into which a sensor (not illustrated) can be at least partially inserted into the protective device 1. The protective device 1 is thus configured as a protective hood.

The front protective element 2 consists of at least one layer containing a material that is easily deformable and at the same time has a high elasticity with sufficiently high stiffness (modulus of shear, modulus of elasticity). This at least one layer may also be reinforced by a fibre system. Materials which are suitable for this at least one layer include cross-linked elastomers (for example FKM (fluororubber), HNBR (acrylonitrile-butadiene rubber) or EPDM (ethylene-propylene-diene rubber)), thermoplastic elastomers (such as TPE-E, TPE-O, TPE-A, TPE-U) or post-cross-linked thermoplastic elastomers (such as TPE-V). In general, however, it is also possible to use steels as long as they are highly ductile, such as metallic materials with a face-centred cubic crystal structure (for example chromium-nickel steels, chromium-nickel-molybdenum steels, chromium-manganese steels or chromium-manganese-molybdenum steels).

If the front protective element 2 consists of several layers, each of these layers may contain a different, highly deformable material, each layer in turn being able to be reinforced by a fibre system. To enable a sensor (not illustrated) located in the protective device 1 to be installed in a device (not illustrated), such as an industrial plant, the protective element 2 has an external thread 5.

Materials that are highly deformable and at the same time have a high elongation at break with sufficiently high stiffness (modulus of elasticity and modulus of shear) are also suitable as materials for the rear protective element 3. These materials may be plastically or elastically deformable.

Suitable materials include cross-linked elastomers (for example FKM (fluororubber), HNBR (acrylonitrile-butadiene rubber) or EPDM (ethylene-propylene-diene rubber)), thermoplastic elastomers (such as TPE-E, TPE-O, TPE-A, TPE-U) or post-cross-linked thermoplastic elastomers (such as TPE-V). The rear protective element 3, like the front protective element 2, may consist of one or more layers of deformable material, each layer being able to be reinforced by a fibre system. In general, however, it is also possible to arrange a metallic material in a layer instead of an elastomer, provided this metallic material is highly ductile. Metallic materials with a face-centred cubic lattice structure are particularly well suited for this purpose. Such metallic materials may, for example, be chromium-nickel steels, chromium-nickel-molybdenum steels, chromium-manganese steels or chromium-manganese-molybdenum steels.

Both the front protective element 2 and the rear protective element 3 thus form active surfaces which can be subjected to impact testing. Together, the front protective element 2 and the rear protective element 3 form the housing 17, which at least partially surrounds the sensor (not shown in FIG. 1). If an impact is applied to the protective elements 2, 3 configured as active surfaces during an impact test, the corresponding active surface (protective element 2 or key element 3) is deformed by the impact energy acting on it because the active surface converts the impact energy into deformation energy. After the active surface is deformed by the impact, this active surface can return to its original shape.

If only the front protective element 2 is intended to form an active surface, the rear protective element 3 may also be made of a different material, such as hard plastic.

The protective device 1 according to FIG. 1 is constructed to be elongated, making it particularly suitable for rod-shaped, for example cylindrical, sensors. However, the protective device 1 may also have other shapes. For example, the protective device may also be constructed in the shape of a box, such as a cube, so that a box-shaped sensor can be inserted into such a protective device 1. The only important thing with these protective devices is that they surround the part of a sensor which can be impacted during an impact test. These protective devices prevent the impact from being applied directly to the sensor. Since the protective device consists of at least one layer of a deformable material, the protective device can convert the impact energy into deformation energy, thereby preventing the impact energy from being forwarded to the sensor and the sensor from being damaged by the impact.

To ensure that a sensor sits firmly in the protective device 1, the protective device 1 has, inside the housing 17, a fastening device (not visible in FIG. 1) with which a sensor can be fixed in the protective device 1. Such fastening devices may be clamping devices, plug connections or threads. This thread can be engaged with a mating thread of the sensor.

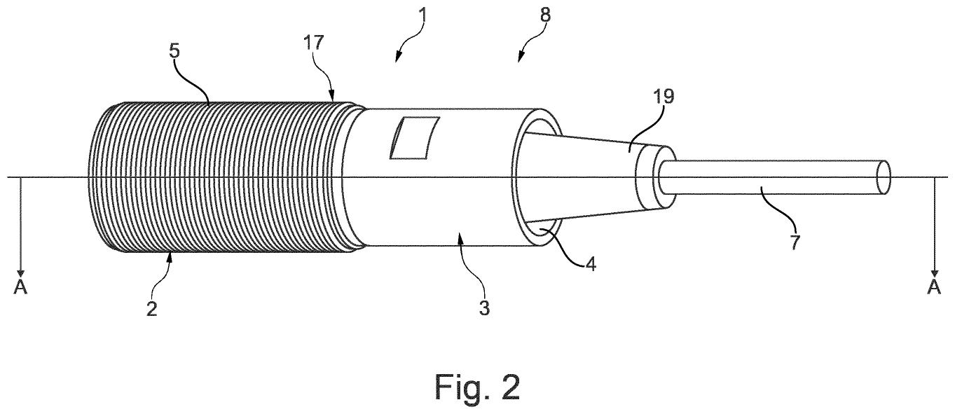

FIG. 2 shows the two-part protective device 1 according to FIG. 1, in which a rod-shaped sensor (not visible because it is located inside the protective device 1) is arranged. Attached to the sensor is a plug connector 19 with an electrical port 7, which is at least partially arranged in the rear protective element 3 of the protective device 1. For this purpose, the sensor has been inserted into the opening 4 so that it sits in the protective device 1. The sensor and the protective device 1 together form an arrangement 8. Since the sensor is surrounded by the protective device 1, it is not necessary for the sensor to consist of a housing made of deformable material because the protective device 1 already consists of at least one layer of such a material, which is highly deformable and at the same time has high elasticity with sufficiently high stiffness (modulus of shear, modulus of elasticity). If the protective device 1 is therefore subjected to an impact test, the protective device 1 completely absorbs the impact energy, preventing it from being forwarded to the sensor arranged in the protective device 1. This protective device 1 therefore prevents the sensor from being damaged in the event of an impact.

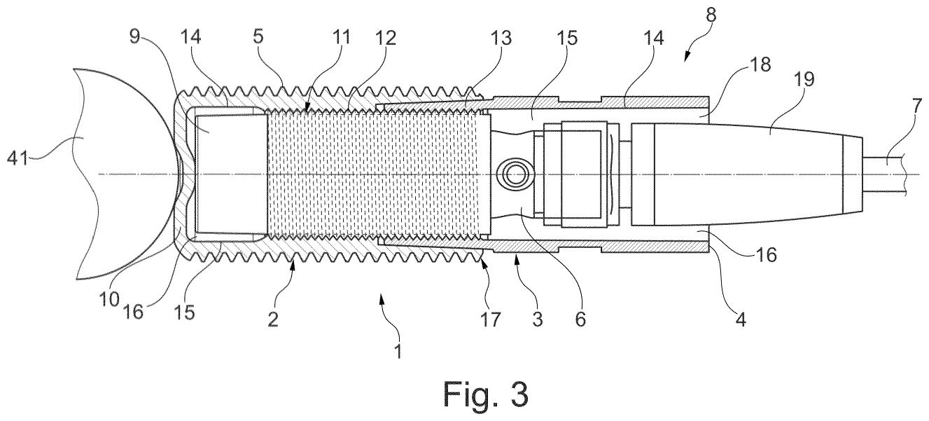

FIG. 3 shows a longitudinal section through the arrangement 8 illustrated in FIG. 2 consisting of the protective device 1 and the sensor 6 arranged therein. The plug connector 19 is fastened to sensor 6 by the electrical port 7. The specific structure of sensor 6 will not be examined in detail below because the sensors which can be arranged in the protective device 1 may also be already known sensors. The only important thing about the sensors is that they are rod-shaped so that they can be fastened in the protective device 1 via a fastening device. It is not necessary for the sensors to be cylindrical, as in this exemplary embodiment.

The sensor 6 is inserted with a front side 9 as far as a front section 10 of the first protective element 2 of the protective device 1 configured as a protective hood. The front section 10 is curved towards the sensor 6 so that a test specimen 41 cannot touch this curved area upon impact to the front side 10 without first deforming the first protective element 2. This curved area thus additionally prevents the test specimen 41 from coming into direct contact with the front section 9 of the sensor 6 upon impact.

The rear protective element 3 is screwed into the front protective element 2. An inner sleeve 11 is arranged in the interior 18 of the protective device 1. This inner sleeve 11 has an external thread 12, via which the inner sleeve 11 can be screwed in by an internal thread 13 of the protective device 1. This internal thread 13 is arranged at least partially on the rear protective element 3 and on the front protective element 2. It is understood that this internal thread 13 may also be provided only on the front protective element 2 or only on the rear protective element 3.

The inner sleeve 13 additionally has a fastening device to which the sensor 6 in the protective device 1 can be fastened. In this exemplary embodiment, the fastening device is configured as an internal thread (not visible) which is arranged in an interior region of the inner sleeve 11 and by which the sensor 6 can be screwed into the protective device 1. For this purpose, the sensor 6 has an external thread (not visible). Such sensors with an external thread are known. However, these sensors are no longer screwed directly into a device, for example an industrial plant; instead, the protective device 1 with the sensor arranged therein is screwed into such a device. No such device is shown in FIG. 3 for clarity.

To ensure that the protective device 1 can be fastened in the device, the protective device 1 has the external thread 5 so that the arrangement 8 consisting of the protective device 1 and the sensor 6 can be easily arranged in such a device or removed again.

It is also conceivable, of course, for the sensor 6 to be attached directly to the internal thread 13. In this case, the sleeve 11 can be omitted. However, an advantage of the sleeve 11 is that it serves as an additional impact protection element-especially if the sleeve 11 consists of at least one layer of a deformable material-which is why it is advantageous to provide this inner sleeve and not to attach the sensor 6 directly to the internal thread 13, which would of course also be possible.

So that the active surfaces, i.e. the rear protective element 3 and the front protective element 2, can deform towards the sensor 6 without coming into contact with this sensor 6 during the deformation, a gap 15 is provided-as additional impact protection-at least partially between the sensor 6 and an internal wall arrangement 14 of the protective device 1. This gap 15 is, in particular, provided where the impact test is performed using the impact test specimen. This gap is filled with an additional impact protection element 16. This additional impact protection element 16 is preferably a gas (for example air or an inert gas) or a foamed material (for example foam resin). A gas is well suited as an impact protection element 16 because it is compressible. Advantageously, the foamed material has a minimum deformability of at least 2%. Foamed materials with a hardness in the range of 10 Shore D to 100 Shore D are particularly suitable. In addition to the minimum requirement of good elasticity, such materials also have sufficiently high material stiffness (modulus of elasticity and modulus of shear). This impact protection element 16 can thus also convert the impact energy into deformation energy. This ensures that when the active surface of the protective device 1 deforms towards the sensor 6, the deformation energy is forwarded to the impact protection element 16, which can also deform. This prevents both the housing 17 of the protective device 1 and the impact protection element 16 from forwarding the impact energy to the sensor 6 and damaging it. Because the protective device 1 ultimately also serves as an impact protection element, the protective device 1 may be regarded as the first impact protection element 1 and the impact protection element 16 as the second impact protection element 16.

It is particularly advantageous if the inner sleeve 11 also consists of at least one layer of a material which is easily deformable and at the same time has a high elongation at break with sufficiently high stiffness (modulus of elasticity and shear modulus). This at least one layer of the inner sleeve 11 can also be reinforced by a fibre system if this at least one layer consists of an elastomer. This allows the inner sleeve 11 to also absorb the deformation energy of the active surface of the protective device 1, thus preventing damage to the sensor 6. After the inner sleeve 11 has absorbed the impact energy forwarded to it by the active surfaces and has thus deformed, the inner sleeve 11 can return to its original shape. In this case, the sleeve 11 represents an additional, third impact protection element.

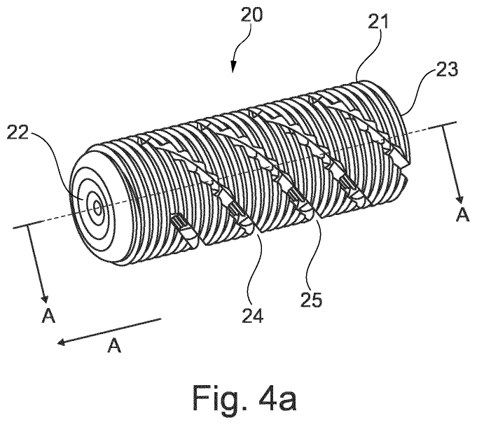

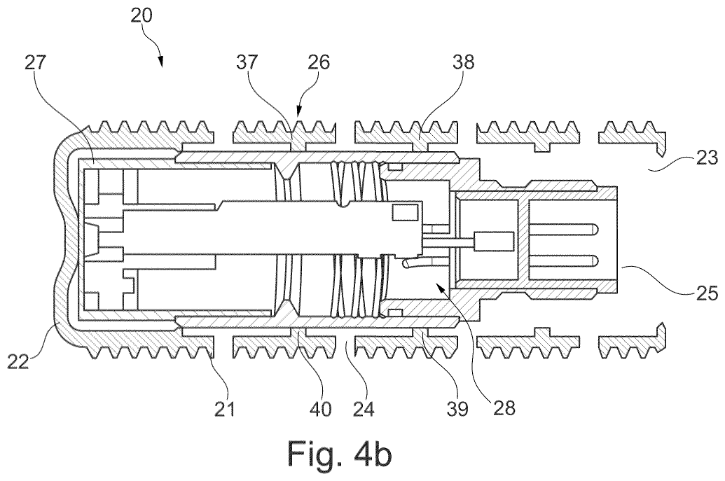

FIG. 4a shows a protective device 20 configured in one part, as a result of which the protective device 20 also simultaneously forms the housing. This protective device 20 consists of a material which is highly deformable and simultaneously exhibits high elongation at break with sufficiently high stiffness (elastic modulus and shear modulus). Suitable materials include cross-linked elastomers (for example FKM (fluororubber), HNBR (acrylonitrile-butadiene rubber) or EPDM (ethylene-propylene-diene rubber)), thermoplastic elastomers (such as TPE-E, TPE-O, TPE-A, TPE-U) or post-cross-linked thermoplastic elastomers (such as TPE-V). These elastomers can be further reinforced by a fibre system. Steels can also be used, provided they exhibit good ductility, as is the case with metallic materials with a face-centred cubic lattice structure (such as chromium-nickel steels, chromium-nickel-molybdenum steels, chromium-manganese steels or chromium-manganese-molybdenum steels). This protective device 20 can also consist of one or more layers of deformable material.

The protective device 20 has an external thread 21 with which the protective device 20 can be screwed into a device, for example an industrial plant. No such device is illustrated in FIG. 4.

Opposite a front section 22 of the protective device 20 is provided an opening 23 into which a sensor can be inserted. A fastening device for fastening the sensor is arranged in an interior region of the protective device 20. This fastening device is shown in FIG. 4b. A section through the protective device 20 illustrated in FIG. 4a is shown therein. The fastening device 26 comprises several threaded holding webs 37 to 40 which are engaged with a housing 27 of the sensor 28 arranged in the protective device 20. The threaded holding webs 37 to 40 are so narrow that they allow a certain axial deformation of the protective device 20 like a spiral spring. Die threaded holding webs 37 to 40 therefore form an impact protection element. As can be seen in FIG. 4b, the threaded holding webs 37 to 40 bridge a gap 42 located between the sensor 28 and the protective device 20. This gap 42 is filled with a gas, for example air. Because the gas is compressible, it forms an additional impact protection element.

This allows the sensor 28 to move relative to the protective device 20 in the event of an impact, thus preventing the impact energy from being forwarded to the sensor 28 and damaging the sensor 28.

The protective device 20 has a spiral-shaped incision 24 running in the longitudinal direction A, which is configured as a spiral-shaped gap 24. If an impact is applied to the front section 22 of the protective device 20, the incision 24 configured as a gap forms an additional impact protection element because the protective device 20 can deform into the incision 24. Instead of this spiral-shaped incision 24, several incisions running in the transverse direction can also be provided, it being possible for these to be arranged either parallel to one another or offset from one another. Such an arrangement of multiple transversely running incisions is not illustrated.

The front section 22 of the protective device 20 is also curved in the direction of the sensor 28 so that a test specimen (not shown) cannot touch this curved area upon impact to the front side 22 without first deforming the protective device 20. This curved area thus additionally prevents the test specimen from coming into direct contact with a front section 29 of the sensor 28 upon impact.

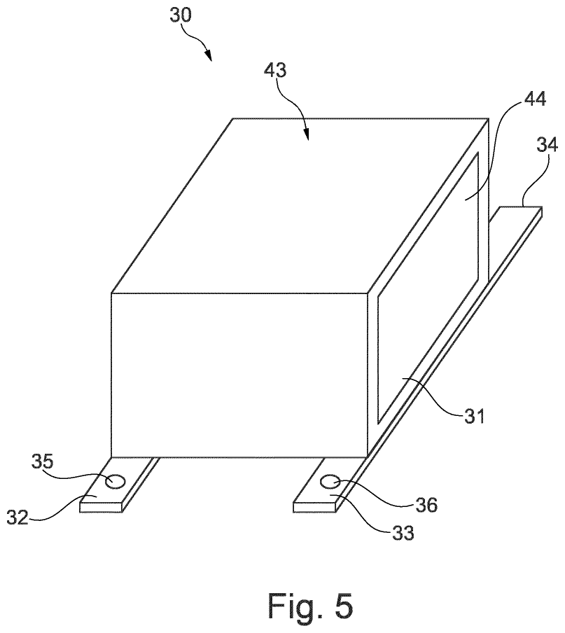

FIG. 5 illustrates a further variant of a protective device 30, which has a housing 43 with an opening 31. This protective device 30 is suitable for box-shaped sensors which are at least partially inserted into the protective device 30 via the opening 31. Located in an interior 44 of the protective device 30 is a fastening device (not visible) for a sensor (also not illustrated), wherein this fastening device can be configured, for example, as a springy suspension or as a clamping element.

The protective device 30 consists-like the other protective devices 1, 20—of at least one layer of a plastically or elastically deformable material. This at least one layer can also be reinforced by a fibre system if necessary. Suitable materials for the protective device 30 include cross-linked elastomers (for example FKM (fluororubber), HNBR (acrylonitrile-butadiene rubber) or EPDM (ethylene-propylene-diene rubber)), thermoplastic elastomers (such as TPE-E, TPE-O, TPE-A, TPE-U) or post-cross-linked thermoplastic elastomers (such as TPE-V). Steels can also be used, provided they are highly ductile, such as metallic materials with a face-centred cubic crystal structure. Such metallic materials include chromium-nickel steels, chromium-nickel-molybdenum steels, chromium-manganese steels or chromium-manganese-molybdenum steels. All of these materials can absorb the impact energy of an impact during an impact test and convert it into deformation energy. As a result, the protective device 30 deforms briefly, but then returns to its original shape. The protective device 30 has several webs 32, 33, 34, each with a passage 35, 36 through which a connecting means can be passed in order to fasten the protective device 30 with the sensor fastened therein to an industrial system or other device (not illustrated). In this case, the protective device 30 comprises four webs, only the three webs 32, 33, 34 being visible. These webs form an impact protection element.

This is advantageous because protective devices can be provided into which a sensor can be at least partially arranged without having to meet the required impact resistance, allowing these protective devices to be used universally. Another advantage is that the protective devices can have various shapes so that even sensors of a wide variety of constructions can be used in the appropriately configured protective devices. Adapting a protective device to a specific sensor is therefore no longer necessary.

All of these protective devices have at least one layer of deformable material which is plastically or elastically deformable. The at least one layer can additionally be reinforced by fibres, suitable materials for such fibres being, for example, polyacrylamides, aramids or even polyethylene, as well as fabrics or braids made from these fibres. Steel fibres can also be used, provided they are not inductive proximity sensors.

The housing for these protective devices can be constructed in one or more parts. For example, as is the case with the protective device 1, it is possible to construct the housing 17 in two parts.

### LIST OF REFERENCE NUMERALS

1 Protective device
2 Protective element
3 Protective element
4 Opening
5 External thread
6 Sensor
7 Electrical connection
8 Arrangement
9 Front side
10 Front section
11 Inner sleeve
12 External thread
13 Internal thread
14 Internal wall arrangement
15 Gap
16 Impact protection element
17 Housing
18 Interior
19 Plug connector
20 Protective device
21 External thread
22 Front section of the protective device 20
23 Opening
24 Spiral-shaped gap
25 Interior
26 Fastening device
27 Housing
28 Sensor
29 Front section of the sensor 28
30 Protective device
31 Opening
32 Web
33 Web
34 Web
35 Passage
36 Passage
37 Threaded holding web
38 Threaded holding web
39 Threaded holding web
40 Threaded holding web
41 Test specimen
42 Gap
43 Housing
44 Interior

1.-13. (canceled)

14. A protective device (1, 20, 30) for a sensor (6), comprising:
a housing (17, 43) with an opening (4, 23, 31) for inserting the sensor (6) into the housing (17, 43),
wherein the housing (17, 43) has at least one layer of a deformable material,
wherein the deformable material has a minimum deformability of at least 2% and a hardness in a range of 10 Shore D to 100 Shore D.

15. The protective device (1, 20, 30) according to claim 14, wherein the housing (17, 43) of the protective device (1, 20, 30) is configured in one or more parts.

16. The protective device (1) according to claim 14, wherein the housing (17) consists of a first, front protective element (2) and a second, rear protective element (3).

17. The protective device (1) according to claim 14, further comprising an internal thread (13) arranged in an interior (18) of the housing (17).

18. The protective device (1) according to claim 17, further comprising
an inner sleeve (11) arranged in the interior (18) of the housing (17), the inner sleeve (11) having an external thread (12),
wherein the inner sleeve (11) is fastened on the internal thread (13) of the housing (17) via the external thread (12).

19. The protective device (1, 20, 30) according to claim 14, further comprising
a fastening device for fastening the sensor in the protective device (1, 20, 30), the fastening device being arranged in an interior (18, 44) of the housing (17, 43).

20. The protective device (1) according to claim 19,
wherein the fastening device is an internal thread of an inner sleeve (11).

21. The protective device (20, 30) according to claim 19,
wherein the fastening device is a clamping element or at least one web (32 to 34).

22. The protective device (1) according to claim 14, further comprising
a gap (15) arranged at least partially between the sensor (6) and an internal wall arrangement (14) of the protective device (1); and
an impact protection element (16) arranged in the gap (15).

23. The protective device (1) according to claim 22,
wherein the impact protection element (16) is a gas, at least one web (32 to 34), or a foamed material.

24. The protective device (1) according to claim 23,
wherein the foamed material has a minimum deformability of at least 2% and a hardness in the range of 10 Shore D to 100 Shore D.

25. The protective device (1, 20, 30) according to claim 14,
wherein the deformable material is a cross-linked elastomer, a thermoplastic elastomer, a post-cross-linked thermoplastic elastomer, or a metallic material with a face-centred cubic lattice structure.

26. The protective device (20) according to claim 14,
wherein at least one incision (24) in the protective device (20) forms an impact protection element (24).
